(19) United States
(12) Patent Application Publication
(10) Pub. No.: US 2024/0188748 A1
(43) Pub. Date: Jun. 13, 2024

(54) KITCHEN APPLIANCE FOR HEATING FOODSTUFFS AND MANUFACTURING METHOD

(71) Applicant: Vorwerk & Co. Interholding GmbH, Wuppertal (DE)

(72) Inventors: Sebastian Tietz, Leverkusen (DE); Simon Reiß, Wipperfürth (DE); Christoph Buggeln, Düsseldorf (DE)

(21) Appl. No.: 18/529,636

(22) Filed: Dec. 5, 2023

(30) Foreign Application Priority Data
Dec. 5, 2022 (EP) 22211419.1

(51) Int. Cl. A47J 27/00; A47J 43/046

(52) U.S. Cl. CPC A47J 27/004; A47J 43/046

(57) ABSTRACT

The present disclosure relates to a kitchen appliance for heating foodstuffs with a wall. A heating conductor for heating foodstuffs is present in the wall. The wall comprises an outer first layer. A second layer of the wall is optionally located between the first layer and the heating conductor. The thermal conductivity of the second layer is greater than the thermal conductivity of the first layer. A first temperature sensor is present in the wall, which contacts the first layer. A second temperature sensor is present in the wall, which is optionally arranged separately from the first layer. It may be sufficient that the first temperature sensor has a large distance, and the second temperature sensor has a small distance to heating conductor tracks. The disclosure also relates to a method for manufacturing the kitchen appliance wherein the first temperature sensor and the second temperature sensor are calibrated. By means of the kitchen appliance target temperatures can be set very precisely.

### PRIORITY CLAIM

This application claims priority to European Application Serial No. 22211419.1 filed Dec. 5, 2022, which is expressly incorporated by reference herein.

### FIELD OF THE DISCLOSURE

The present disclosure relates to a kitchen appliance for heating foodstuffs. The disclosure also relates to a method for manufacturing the kitchen appliance.

### BACKGROUND

From the publications EP 3498136 B1 and WO 2020/000052 A1 kitchen appliances with electrical heating devices and temperature elements are known.

### SUMMARY

The present disclosure is intended to create a kitchen appliance which is robust, which can be manufactured in a technically simple manner, and which can determine temperatures in a particularly suitable manner in order to be able to heat foodstuffs in a suitable manner.

To solve the problem, a kitchen appliance may be provided for heating foodstuffs. A kitchen appliance is an appliance that is used in a kitchen for preparing foodstuffs. Examples of a kitchen appliance for heating foodstuffs are an oven, a grill, a microwave, a coffee machine, a food processor or a hob.

The kitchen appliance may comprise a wall. Wall means a flat component with a closed surface. A wall is liquid-tight due to its closed surface. The wall can be part of a cooking chamber or a preparation vessel of the kitchen appliance. The wall may be a side wall of a cooking chamber or a preparation vessel. The wall may form the bottom of a cooking chamber or the bottom of a preparation vessel. The wall may form the ceiling of a cooking chamber.

The kitchen appliance may comprise one or more heating conductors for heating the foodstuff. A heating conductor is an elongated object that can be heated and extend along a line. The line may be a circle or a pitch circle. The heating conductor then extends along a circular shape or along a partial circle. The line may be arc-shaped. The heating conductor then runs along an arc shape. For example, a heating conductor may be an electrical conductor that heats up when electrical current flows through the electrical conductor. Such a heating conductor may consist of a heating conductor alloy. The electrical resistance of a heating conductor at 20° C. may be at least

$${0.2}^{\frac{Ω \cdot {mm}^{2}}{m}} or at least {0.5}^{\frac{Ω \cdot {mm}^{2}}{m}} or at least {1}^{\frac{Ω \cdot {mm}^{2}}{m}} .$$

A heating conductor may be a tube through which a hot medium such as heated oil can flow. The tube may consist of metal. A heating conductor may extend back and forth in a track-shaped manner to heat a surface.

The one or more heating conductors may be present in the wall. A heating conductor present in a wall is not accessible from the outside. The wall then protects the heating conductor from external influences.

The wall may comprise a first layer. By layer is meant a mass of a material spread in a sheet-like manner. The first layer is an outer layer and thus visible from the outside and accessible from the outside.

The wall may comprise a second layer. The second layer of the wall may be located between the first layer and the one or more heating conductors. The second layer then separates the heating conductors from the first layer. There is then no direct contact between the heating conductor(s) and the first layer. Basically, the second layer is in the wall and thus not accessible from the outside and basically also not visible. The second layer is therefore not an outer layer of the wall.

A first temperature sensor may be present in the wall. If a temperature sensor is present in the wall, then the temperature sensor is located between two layers inside the wall. A part of the temperature sensor then does not protrude from the wall to the outside. Consequently, a temperature sensor does not extend through a layer of the wall. Thus, the temperature sensor is then protected from damage by the wall. In this way, the present disclosure differs, for example, from the prior art known from the publication EP 3813616 A1 or WO 2020000052 A1.

A temperature sensor is a component by which a temperature can be determined. A temperature sensor may be a component that can generate an electrical signal as a measure of a temperature. A temperature sensor present in the wall is present and configured such that a control device can obtain from the temperature sensor the measure of temperature for regulating (controlling) the kitchen appliance. Externally accessible electrical contacts may be present, via which the temperature sensor can be electrically connected to electrical contacts of the control device. The control device may regulate the operation of the kitchen appliance in dependence on the measure of temperature if the electrical contacts of the control device are connected with the electrical contacts of the temperature sensor. However, a control device may also be permanently connected to the temperature sensor such that the control device can regulate the operation of the kitchen appliance depending on the temperature.

The first temperature sensor may contact the first layer. If the first temperature sensor contacts the first layer, then there is a direct physical connection between the first temperature sensor and the first layer. The contacting will achieve that the first temperature sensor can measure a temperature of the first layer, or at least a temperature that is close to the temperature of the first layer.

A second temperature sensor may be present in the wall. The second temperature sensor may be arranged separately from the first layer. The second temperature sensor may be adjacent to the second layer. Only the second layer then separates the second temperature sensor from the first layer. If the second sensor is arranged separately from the first layer, then there is no direct physical connection between the second temperature sensor and the first layer. It is thereby achieved that a temperature is determined by the second temperature sensor that prevails inside the wall.

The described arrangement of the two temperature sensors ensures that during heating of the one or more heating conductors, the first temperature sensor measures a temperature during the usual preparation of foodstuffs that is below the temperature measured by the second temperature sensor. By the first temperature sensor a temperature is determined that is at least close to the temperature of the first layer at the location of the measurement. The first temperature sensor can thus provide information about the temperature acting on a foodstuff during its preparation. The second temperature sensor determines a temperature that prevails inside the wall. The second temperature sensor can thus provide information about how the temperature of the first layer and thus also of the wall will change. Overall, it can therefore be estimated in an improved manner how the temperature of the first layer and thus also of the wall will behave. This can be used to be able to heat a foodstuff in a particularly suitable manner. For example, residual heat can be exploited to minimize the energy required to prepare a foodstuff by heating it.

The distance between the first temperature sensor and an adjacent heating conductor may be greater than the distance between the second temperature sensor and an adjacent heating conductor. The first temperature sensor is then further away from heating conductors than the second temperature sensor. Also in this way, it can be alternatively or complementarily achieved that the first temperature sensor determines the temperature of the first wall and the second temperature sensor determines the temperature generated inside the wall by the one or more heating conductors.

The second temperature sensor may contact the second layer. The temperature that the second temperature sensor measures then corresponds to the temperature of the second layer or then at least comes close to this temperature.

The heating conductor may contact the second layer. During heating, it is thus achieved that the temperature of the second layer and the temperature of the heating conductor are brought particularly close to each other. Local heating in the interior of the wall can thus advantageously avoided particularly well.

The heating conductor may be separated from the second layer only by an electrical insulator. This embodiment is significant if the heating conductor is an electrical heating conductor, and the second layer consists of an electrically conductive material. Advantageously, local heating inside the wall can thus be particularly well avoided.

The measurement accuracy of the first temperature sensor may be greatest at a first temperature and the measurement accuracy of the second temperature sensor may be greatest at a second temperature. The second temperature may be greater than the first temperature. For example, the first temperature sensor may measure a temperature of 100° ° C. with an accuracy of +0.5° C. and any other temperature with a lower accuracy. The first temperature is then 100° C. For example, the second temperature sensor may measure a temperature of 200° C. with an accuracy of +0.5° C. and any other temperature with a lower accuracy. The second temperature is then 200° C. and, thus, greater than the first temperature. The measurement accuracy of the first temperature sensor may be greatest at the first temperature because the first sensor has been calibrated at the first temperature. The measurement accuracy of the second temperature sensor may be greatest at the second temperature because the second sensor has been calibrated at the second temperature. The second temperature is greater than the first temperature because higher temperatures are to be measured by the second temperature sensor than by the first temperature sensor.

The difference between the first temperature and the second temperature may be more than 20° C. or more than 50° C. or more than 90ºC. It may be that the difference between the first temperature and the second temperature is no more than 150° C. or no more than 120° C. These differences may occur during a heating phase. This takes into account which temperature differences between the first temperature and the second temperature are of particular interest to be able to optimize a foodstuff preparation by heating. After a heating phase, the difference can be significantly smaller. For example, the difference may then be only 2ºC or only 3ºC or only 4° C. After a heating phase, the difference can be, for example, a maximum of 20° C. or a maximum of 18° C. or a maximum of 15° C. During the heating phase, the difference may also vary, wherein in one embodiment this difference may be dependent on the current measured temperature by the first and/or second temperature sensor.

The first temperature sensor and/or the second temperature sensor may be pressed against the first and/or, if applicable, second layer by a spring. The spring is then preloaded. If a temperature sensor is pressed against a layer by means of a spring. This ensures a good thermal connection by means of a sufficiently large contact force, so that no large thermal resistances in the form of air bridges can arise and thus the measurement signal is not delayed or distorted by an offset. This provides a good thermal connection for accurate temperature determination. The holding is insensitive to thermal stresses. It can thus be achieved in an improved manner in the case of the first temperature sensor that the first temperature sensor can rapidly measure a temperature corresponding to the temperature of the first wall. It can thus be achieved in an improved manner in the case of the second temperature sensor that the second temperature sensor can rapidly measure a temperature corresponding to the temperature of the second wall.

The first temperature sensor may be arranged such that the first temperature sensor does not contact the second layer. It can thus be achieved in an improved manner that the first temperature sensor measures a temperature corresponding to the temperature of the first wall.

The first temperature sensor may not be arranged between two heating conductor tracks. It is thus advantageously achieved in an improved manner that the temperature measured by the first temperature sensor is influenced as little as possible by temperatures of the one or more heating conductors.

The second temperature sensor may be arranged between two heating conductor tracks. It is thus advantageously achieved in an improved manner that the temperature measured by the second temperature sensor corresponds as much as possible to the temperatures of the one or more heating conductors.

The first layer may consist of steel. The first layer may consist of a stainless steel. All outer surfaces of the wall may consist of steel, such as stainless steel.

Advantageously, this makes the wall particularly stable. The second layer may consist of copper or aluminum, or comprise copper or aluminum, because the thermal conductivity of copper or aluminum is advantageously high.

The kitchen appliance may comprise a control device. The control device may control the operation of the kitchen appliance and/or of another appliance. For example, the control device may be configured such that it is able to control heating of the heating conductors. For example, the control device may be configured such that a temperature may be selected by a user. Subsequently, the control device controls the heating so that the selected temperature is reached and thereafter maintained. For example, the control device may be configured such that a temperature may be predetermined by an electronically stored recipe. Subsequently, the control device controls heating so that the predetermined temperature is reached and thereafter maintained.

The control device may be configured such that it controls heating by the heating conductors in response to the first and second temperature sensors during preparation of foodstuffs. The control device can thereby control the preparation of foodstuffs not only in dependence on the temperature directly acting on a foodstuff, but also in dependence on expected temperature changes due to the temperature prevailing inside the wall. Foodstuffs can thus be controlled in an improved manner by heating.

The control device may be configured such that it controls setting a target temperature with the first temperature sensor when the target temperature is low. The control device may be configured such that it controls the setting of a target temperature with the second temperature sensor when the target temperature is high. This is particularly true if the first temperature sensor has been calibrated at a temperature that is lower than the temperature at which the second temperature sensor has been calibrated. For example, a small target temperature may be less than 130° C. A large target temperature is then greater than 130° C.

The control device may be configured such that it controls the setting of a target temperature with the first temperature sensor when a liquid is simmering or boiling. The control device may be configured such that it controls the setting of a target temperature with the second temperature sensor when a foodstuff such as meat is to be fried (seared).

The control device may be configured such that it switches off heating by the one or more heating conductors when the first temperature sensor measures a temperature above a first threshold value. Alternatively or additionally, the control device may be configured such that it switches off heating by the one or more heating conductors when the second temperature sensor measures a temperature above a second threshold value. Undesired overheating can thus be avoided.

For example, the control device may be configured such that it switches off the heating of heating conductors as soon as the temperature of the second layer reaches a temperature of 295° C. or 290° C., taking into account the measurement accuracy of the first and/or the second temperature sensor.

The first threshold value may be smaller than the second threshold value. It is then taken into account that the first temperature sensor basically determines lower temperatures than the second temperature sensor. An undesired overheating can thus be avoided in a further improved manner.

The first threshold value may be greater than 180ºC and/or less than 280° C. to avoid undesired overheating. The first threshold value may be greater than 200° C. and/or less than 295ºC to avoid undesired overheating. The first threshold value may be greater than 240° C. and/or less than 250° C. to avoid undesired overheating. The first threshold value may be 245° C. The second threshold value may be greater than 240° C. and/or less than 320° C. to avoid undesired overheating. The second threshold value may be greater than 250° C. and/or less than 270° ° C. to avoid undesired overheating. The second threshold value may be 260° C.

In one embodiment, the measurement accuracy of the two temperature sensors is taken into account when selecting the temperature at which switching off is performed. For example, if the temperature of the one or more heating conductors is not to exceed 260° C. and the measurement accuracy of the second temperature sensor at 260° C. is +4° C., for example, 255° C. or 256° C. is selected as the threshold value for the second temperature sensor.

The thermal conductivity of the second layer may be greater than the thermal conductivity of the first layer. Thermal conductivity is a material property that determines the flow of heat through a material based on thermal conduction. If the thermal conductivity of the second layer is greater than the thermal conductivity of the first layer, then heating in the second layer will propagate faster than the same heating in the first layer if both layers are of equal dimensions. The thermal conductivity in the SI system has the unit watts per meter and kelvin. If the one or more heating conductors are heated, the second layer causes the first layer to be heated particularly evenly. Disadvantageous local heating of the first layer can therefore be avoided.

The second layer may be thicker than the first layer. It can thus be achieved in an improved manner that the first layer is heated particularly uniformly. For example, the second layer can be at least twice as thick or at least three times as thick as the first layer. A technically reasonable upper limit is that the second layer is no more than seven times or no more than six times as thick as the first layer. The second layer may be five times as thick as the first layer.

The kitchen appliance may be a food processor with a stand part, with a preparation vessel insertable into the stand part, and with a chopping and/or mixing device. The preparation vessel comprises the wall. Foodstuffs in the preparation vessel are heated when one or more heating conductors in the wall are heated. By means of the chopping and/or mixing device, a foodstuff present in the food preparation vessel can be chopped and/or mixed. The chopping and/or mixing device may comprise a stirring and/or cutting tool. The chopping and/or mixing device may comprise an electric drive for the stirring and/or cutting tool. The electric drive for the stirring and/or cutting tool may be in the stand part. The aforementioned control device may, for example, be arranged in the stand part. The control device may be configured such that the control device is able to control the electric drive, for example in dependence on an electronically stored recipe by which is predetermined how a foodstuff is prepared.

The disclosure also relates to a method of manufacturing a kitchen appliance. The manufacturing comprises calibrating the first temperature sensor and the second temperature sensor, wherein the maximum calibration temperature of the first temperature sensor may be less than the maximum calibration temperature of the second temperature sensor. In one alternative, the calibration temperatures for both temperature sensors are the same. and are, for example, 120° C. Through calibration a temperature sensor is compared to a reference temperature sensor. For example, if a temperature sensor is calibrated at a calibration temperature of, say, 100° C., then a temperature is generated at which the reference temperature sensor reads 100° C.

Subsequently, the signal that the temperature sensor generates is determined. It is now stored that this signal means that a temperature of 100° C. is present. Since a reference temperature sensor is configured such that it is able to measure desired temperatures very accurately, after calibration the calibrated temperature sensor also measures at least the calibration temperature very accurately.

The maximum calibration temperature of the first temperature sensor may advantageously be between 50° C. and 150° C. or between 80ºC and 120° C. The maximum calibration temperature of the second temperature sensor may advantageously be between 150° C. and 250° C. or between 180ºC and 220° C.

Each temperature sensor may have been calibrated at several different calibration temperatures. It is also possible that the maximum calibration temperature of the first temperature sensor is merely different than the maximum calibration temperature of the second temperature sensor.

A temperature sensor may be designed so that the temperature sensor can most accurately measure a particular temperature. This temperature is called the operating point with the highest accuracy. For example, if the operating point with the highest accuracy is 100° C. due to manufacturing, then the sensor can measure the temperature of 100° C. more accurately than other temperatures. For example, the sensor can then measure a temperature of 100° C. with ±0.5° C. accuracy, but a temperature of 50° C. with an accuracy of only ±2° C., for example, and a temperature of 150° C. with an accuracy of only ±3.5° C., for example. Preferably, the operating point with the highest accuracy of the first temperature sensor is smaller than the operating point with the highest accuracy of the second temperature sensor. Thus, for example, the first temperature sensor has been produced in such a way that it can measure 100° C. particularly accurately. Its operating point with the highest accuracy is then 100° C. The second temperature sensor has then been produced, for example, in such a way that it can measure 200° C. particularly accurately. Its operating point with the highest accuracy is then 200° C. and thus greater than that of the first temperature sensor. The accuracy of the temperature measurements can thus be further improved.

Preferably, the first temperature sensor is calibrated at the operating point with the highest accuracy of the first temperature sensor. Preferably, the second temperature sensor is calibrated at the operating point with the highest accuracy of the second temperature sensor. By “at the operating point with the highest accuracy” is meant that the calibration temperature corresponds to the temperature that is specified at the factory, for example by the manufacturer of the temperature sensor, as the operating point with the highest accuracy. The operating point with the highest accuracy may be the maximum temperature with which a temperature sensor is calibrated. This is especially the case when calibration is performed at only one temperature.

For example, the temperature sensors may be NTC (Negative Temperature Coefficient) sensors and/or PTC (Positive Temperature Coefficient) sensors.

By the description of the presently disclosed devices and methods it is achieved that temperature sensors can be used not only to be able to control a preparation of foodstuff in an improved manner, but also for safety reasons when excessively high temperatures are exceeded. There is no need to compromise on the design of a temperature sensor. It is possible to determine very accurately the temperature to which foodstuffs are exposed during preparation without having to switch off heating by heating conductors. This means that no time delays have to be accepted. In addition, the effort required for programming is then low. The temperature sensors are well protected from external influences. There is no risk of leakage due to temperature sensors, as the temperature sensors are located completely inside the wall and therefore do not protrude from the wall. Uneven heat distribution around a temperature sensor can be avoided. The calibration effort for the temperature sensors can be kept low, since it is sufficient to calibrate each temperature sensor at only one temperature. The calibration effort is particularly low if calibration is performed at only one temperature, which can be between 90° ° C. and 150° C., for example. Thermal energy present in the wall can be determined and taken into account in the preparation of foodstuffs. Thus, a disadvantageous overshooting of a temperature of the first layer can be avoided. Temperatures can be set very precisely over a wide temperature range from, for example, −30° C. to 225° C. A large temperature range can be set very precisely, since one or the other temperature sensor can be used for a control depending on the target temperature. This is especially true in the case where the two temperature sensors have been calibrated at different temperatures. Thus, for example, it can be estimated when at the earliest the heating of one or more heating conductors can be switched off in order to be able to use residual energy for the preparation. Control can advantageously be suitably performed by a cascade control or by a state controller. The kitchen appliance of the present disclosure can be implemented with different heating conductors. The first layer can be used as a support surface for foodstuffs. Safety switches such as bimetal switches or fuses can be omitted.

### BRIEF DESCRIPTION OF THE DRAWINGS

The figures show

FIG. 1: Layer system with heating conductor and temperature sensors;

FIG. 2: Food processor;

FIG. 3: Further layer system with heating conductor and temperature sensors;

FIG. 4: Section through a system with two layers;

FIG. 5: Section through a system with two layers;

FIG. 6: Section through a system with two layers;

FIG. 7: Section through detail of a wall;

FIG. 8: Measurement accuracy of first and second temperature sensor;

FIG. 9: Layer with heating conductor and temperature sensors.

### DETAILED DESCRIPTION

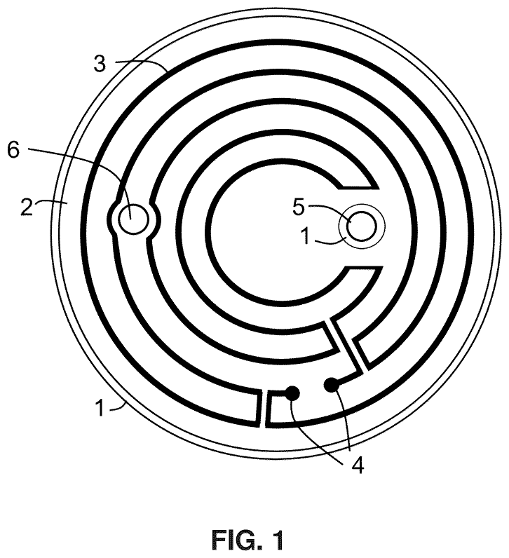

FIG. 1 shows a top view of a first layer 1 to which a second layer 2 has been applied. The first layer 1 consists of a different material than the second layer 2. In the second layer 2 there is an opening through which the first layer 1 can be seen. An electrical heating conductor 3 with electrical contacts 4 is applied to the second layer 2. The heating conductor 3 can form a thick-film heater. The electrical heating conductor 3 runs predominantly along circular tracks in order to be able to heat the second layer 2 over its surface. The electrical heating conductor 3 has electrical contacts 3 at its two ends. The electrical contacts 3 can be connected to a power source for heating the heating conductors. A first temperature sensor 5 is located on the first layer 1 within the opening of the second layer 2. The temperature sensor 5 therefore contacts the first layer 1. The edge of the opening of the second layer 2 does not contact the first temperature sensor 5. There is therefore no contact between the second layer 2 and the first temperature sensor 5. The first temperature sensor 5 is located away from tracks of the heating conductor 3. A second temperature sensor 6 is located on the second layer 2 in close proximity to two tracks of the heating conductor 3. Tracks of the heating conductor 3 may be arranged circular in sections around the second temperature sensor 6 to allow heating conductor temperatures to be determined in a further improved manner by the second temperature sensor. The distance between the second temperature sensor 6 and the heating conductor 3 is less than the distance between the first temperature sensor 5 and the heating conductor 3.

The heating conductor 3 may be provided with an electrical insulation which electrically separates the heating conductor 3 from the second layer 2. An electrically insulating layer may be present between the heating conductor 3 and the second layer 2. On the heating conductor 3 or above the heating conductor 3 at least one further layer is present, which is an outer layer of the wall. The first layer 1 and at least the one further layer may consist of steel. The second layer 2 may consist of aluminum or copper or comprise aluminum or copper. Altogether, a wall can be formed which is part of a kitchen appliance.

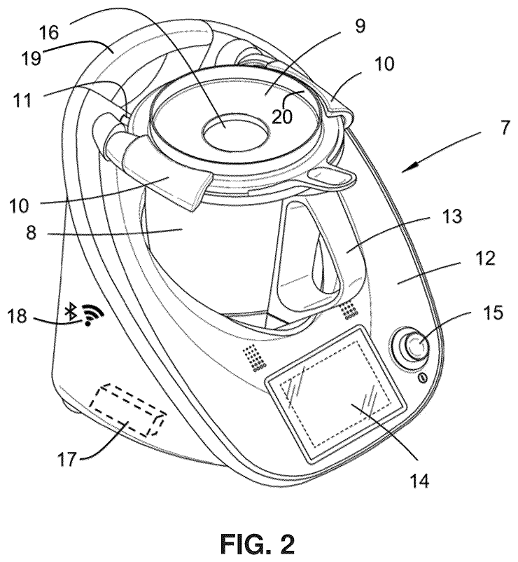

FIG. 2 shows a food processor 7 as an example of a kitchen appliance with a food preparation vessel 8. A lid part 9 is placed on the food preparation vessel 8. The lid part 9 for the food preparation vessel 8 is locked by arms 10. The lid part 9 is located between the two arms 10. The arms 10 can be rotated about their longitudinal axis by a motor of the food processor, and thus back and forth between an open position and a locked position. The lid part 9 has pressed down and thus released a sensor, namely a toggle lever 11 of an electric switch. The arms 10 and the toggle 11 are attached to a stand part 12 of the food processor 7. The food preparation vessel 8 is inserted into the stand part 12 and can be removed from the stand part 12. In order to be able to remove the food preparation vessel 8, this comprises a handle 13. For operation, the stand part 12 comprises a touch-sensitive display 14 and a rotary switch 15. The rotary switch 15 can be rotated and pressed. Display 14 and rotary switch 15 are thus operating elements of the food processor 7. Data can be entered via the operating elements 14 and 15. The lid part 9 comprises an opening 16 in the center, which can be closed with a closure not shown, for example a vessel-like closure.

A control device 17 is located in the stand part 12. A radio device 18 is located in the stand part 12, via which data can be sent and received wirelessly. The radio device 18 can, for example, send and receive data via Bluetooth and/or Wi-Fi. The control device 17 can, for example, access an externally electronically stored recipe via the radio device 18. The control device 17 can control the preparation of a food by means of the recipe. Alternatively or additionally, recipes can also be stored in a memory unit of the control device. The control device 17 may control the operation of the food processor 7 and/or the operation of another kitchen appliance. The control device 17 may receive information about temperatures from the two temperature sensors 5 and 6. The control device may control the preparation of the food depending on the measured temperatures. In particular, the control device can control the heating power of the heating conductor 3, i.e. the power supply to the heating conductor.

In the food preparation vessel 8 there is a mixing and/or cutting tool which can be driven by a motor. The motor is located in the stand part 12. A heating device is present in the base (bottom) of the food preparation vessel 8, which can be electrically connected to the stand part 12 for heating. The motor for rotating the arms 10 is also arranged in the stand part.

The stand part 12 has a handle 19 on its upper side. The lid part 9 has an upwardly projecting, annular collar 20.

The wall of FIG. 1 may be the bottom of the preparation vessel 8. The wall of FIG. 1 may then have a passage for a shaft in the middle. The shaft can, for example, be connected to the mixing and/or cutting tool and be connected to the shaft of an electric drive or motor when the preparation vessel 8 is inserted into the stand part 12.

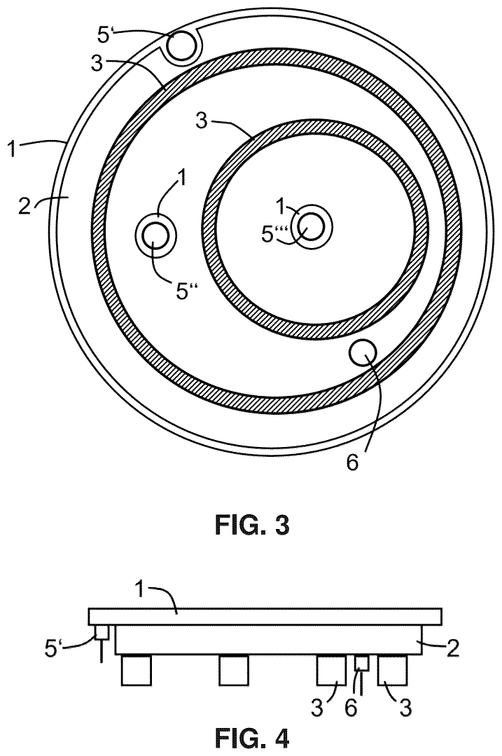

As in the case of FIG. 1, FIG. 3 shows a top view of a first layer 1 to which a second layer 2 is applied. Two schematically shown heating conductors 3 are applied to the second layer 2. Each heating conductor 3 extends in a circular manner, wherein contacts have not been shown. Each heating conductor 3 may be an electric tubular heater. It is possible that the two heating conductors can be energized independently of each other. Deviating from the shown circular shape, a heating conductor 3 may run in an arc-shaped (arcuate) manner at least in sections or completely, for example like an oval. A heating conductor 3 may run in an angular shape in sections or completely. A heating conductor 3 may run in a straight line in sections or completely. A heating conductor 3 can thus also run at least in sections in an arcuate shape and/or at least in sections in a straight line and/or at least in sections in an angular shape.

One heating conductor 3 has a large diameter and/or, in the case of an arcuate course, a large extension, namely in comparison to the diameter and/or the extension of the other heating conductor 3. The heating conductor 3 with the small diameter is arranged off-center within the other heating conductor 3. Due to the off-center arrangement, there is a small distance between the two heating conductors 3 on the side shown on the right and a large distance between the two heating conductors 3 on the side shown on the left. The second temperature sensor 6 is arranged on the second layer 2 between the two heating conductors 3 on the right, so that the second temperature sensor 6 has a small distance to the two heating conductors 3. The second temperature sensor 6 can therefore estimate a temperature of a heating conductor 3 even if the other heating conductor is not being heated, i.e. is not being energized. The first temperature sensor is arranged on the first layer 1 in such a way that it is at a large distance from the two heating conductors 3. Three different arrangements of the first temperature sensor are shown. The first temperature sensor 5′ may thus be located outside the two heating conductors 3. The first temperature sensor 5′ may thus be arranged at the edge of the wall, for example, in order to be exposed to as little temperature as possible from heating conductors 3. The first temperature sensor 5″ may be located centrally between the two heating conductors 3 on the side shown on the left. The first temperature sensor 5″ may be located centrally inside the heating conductor 3 with the small diameter. There may also be several first temperature sensors 5′, 5″, 5″, which have a large distance to heating conductor tracks and which are located on the first layer 1. There may also be several second temperature sensors 6, which have a small distance to heating conductor tracks.

By “small” and “large” it is meant that the one small distance is small compared to the other large distance. The same applies to the small and the large diameter.

FIG. 4 shows a section through the system with the two layers 1 and 2 for the case that there are two circular heating conductors 3 as shown in FIG. 3. The first temperature sensor 5′ is located on the left side outside the two heating conductors 3 on the first layer 1. The second temperature sensor 6 is arranged on the right side between the two heating conductors 3 on the second layer 2. FIG. 4 illustrates that the first temperature sensor 5′ is arranged in a different plane than the second temperature sensor 6. This helps to ensure that the first temperature sensor 5′ can be used to determine quite accurately the temperature to which foodstuffs are subjected during their preparation, even during heating of the heating conductors 3. For this to work well, the edge of the second layer 2 adjacent to the first temperature sensor 5′, 5″, 5″ may have a significant distance to the first temperature sensor 5′, 5″, 5″. This distance may be at least 5 mm or at least 7 mm. For example, a circular opening in the second layer 2 may have a diameter of 20 mm to 30 mm. For example, the diameter may be 25 mm. A first temperature sensor may be arranged within the opening, the diameter of which is significantly smaller and is, for example, smaller than 14 mm or smaller than 10 mm.

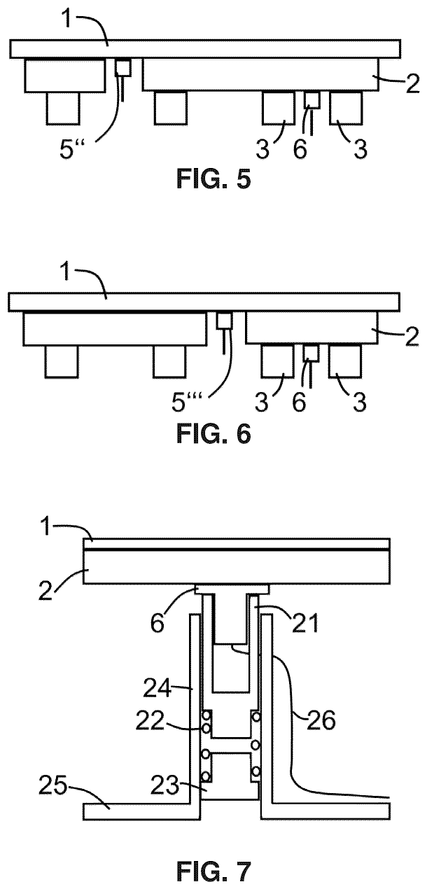

In FIG. 5, the case is sketched in section that the first temperature sensor 5″ is arranged between the two circular heating conductors 3, as shown in FIG. 3.

In FIG. 6, the case is sketched in section that the first temperature sensor 5″ is arranged centrally within the heating conductor 3, which has the small diameter.

FIG. 7 shows in a sectional view a detail of a wall with the first layer 1, the second layer 2 and the second temperature sensor 6. The second temperature sensor 6 is pressed against the second layer 2 by means of a punch 21 and a pretensioned spring. The temperature sensor 6 may be T-shaped. The lower part of the T-shape may extend into a recess in the punch 21 as shown in FIG. 7. The upper part of the T-shape then rests against the second layer 2. The other end of the punch 21 may taper in a stepped manner. The spring 22 may be a coil spring. One end of the spring 22 may rest on the step of the punch 21, as shown in FIG. 7. The other end of the spring 21 may be supported against a cap 23. The cap 23 may have a stepped end. One end of the coil spring 21 may be supported against the step of the step-shaped end of the cap 23. Any end of the spring 21 that is supported on a step is thereby held stably.

The cap 23 may be inserted into a sleeve 24. The cap 23 may be screwed into the sleeve 24, for example. The cap 23 may be welded to the sleeve 24.

The sleeve 24 may protrude from a further layer 25 of the wall towards the second layer 2. The sleeve 24 may be permanently connected to the further layer 25, for example welded, or may have been manufactured in one piece together with the further layer 25. The sleeve 24 may be screwed to the further layer 25, for example. The punch 21 may be guided through the sleeve 24. The further layer 25 may consist of steel, as does the first layer 1. The further layer 25 may be an outer layer of the wall as shown.

The temperature sensor 6 may be connected to the control device 17 of the food processor 7 via an electrical conductor 26. The plunger 21 and the sleeve 24 may have recesses through which the electrical conductor 26 is passed.

In the same way, a first temperature sensor 5 can also be held inside the wall.

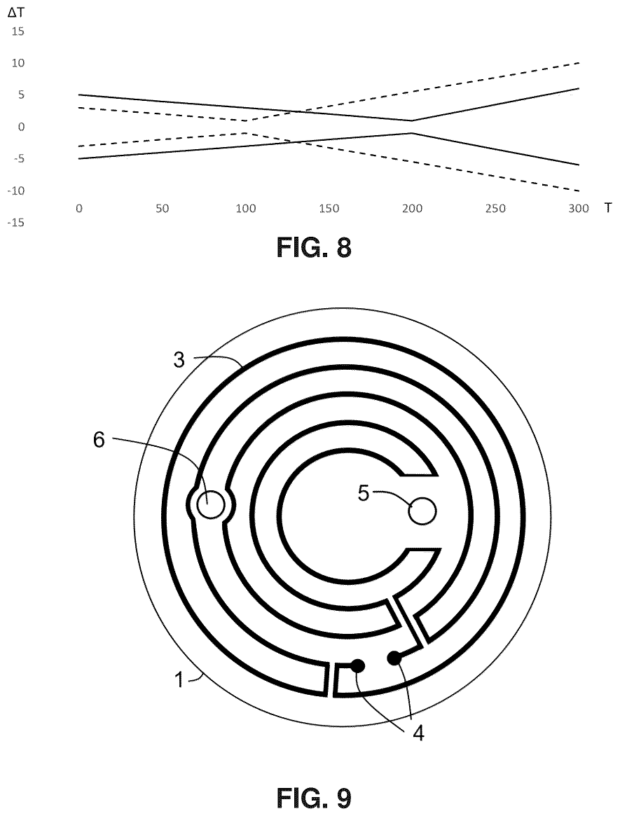

FIG. 8 illustrates the measurement accuracy of the first temperature sensor 5 and the second temperature sensor 5. The measurement accuracy AT in ° C. is plotted as a function of the temperature T in ° C. The dashed lines illustrate the measurement accuracy of the first temperature sensor 5. The solid lines illustrate the measurement accuracy of the second temperature sensor 6.

The first temperature sensor 5 has been calibrated at 100° C. At 100° C., the measurement accuracy of the first temperature sensor 5 is therefore at its highest and is +1ºC. At 300° C., the measurement accuracy of the first temperature sensor is +10° C. At 0° C., the measurement accuracy of the first temperature sensor is +5° C. The measurement accuracy deteriorates linearly starting from 100° C.

The second temperature sensor 6 has been calibrated at 200° C. At 200° C., the measurement accuracy of the second temperature sensor 6 is therefore at its highest and is #1° C. At 300° ° C. the measurement accuracy of the second temperature sensor is +5° C. At 0° C., the measurement accuracy of the second temperature sensor is +3ºC. The measurement accuracy deteriorates linearly starting from 200° C.

The second layer 2 shown in FIG. 1 can be omitted. Nevertheless, mentioned advantages can be achieved, because heating conductor tracks of a heating conductor 3 are close to the second temperature sensor 6, whereas the distance between the first temperature sensor 5 and adjacent heating conductor tracks is significantly larger. This case is shown in FIG. 9.

By means of the present disclosure, the temperature of the one or more heating conductors, for example a pipe heating temperature, can be monitored very precisely. A disadvantageous overshooting of a temperature can be avoided. Energy stored, for example, in a tube heater or in the second layer can be taken into account, for example, to avoid overshooting of a temperature and/or to exploit residual heat. Temperatures can be precisely controlled over a wide temperature range from, for example, −30° C. to 225° C. Reliable overheating protection is possible.

1. A kitchen appliance for heating foodstuffs, the kitchen appliance comprising
a wall, and
a heating conductor for heating food, the heating conductor being present in the wall, wherein the wall comprises an outer first layer, wherein a second layer of the wall is located between the first layer and the heating conductor, wherein a first temperature sensor contacting the first layer is present in the wall, and wherein a second temperature sensor arranged separately from the first layer is present in the wall

2. The kitchen appliance of claim 1, wherein the wall comprises an outer first layer and, in the wall, a heating conductor, a first temperature sensor and a second temperature sensor, and wherein the distance between the first temperature sensor and the heating conductor is greater than the distance between the second temperature sensor and the heating conductor.

3. The kitchen appliance of claim 1, wherein the second temperature sensor contacts the second layer or that the second temperature sensor is separated from the second layer only by an electrical insulator.

4. The kitchen appliance of claim 1, wherein the measurement accuracy of the first temperature sensor is greatest at a first temperature and the measurement accuracy of the second temperature sensor is greatest at a second temperature, wherein the second temperature is greater than the first temperature.

5. The kitchen appliance of claim 4, wherein the difference between the first temperature and the second temperature is more than 2ºC.

6. The kitchen appliance of claim 4, wherein the difference between the first temperature and the second temperature is more than 4° C.

7. The kitchen appliance of claim 4, wherein the difference between the first temperature and the second temperature is not more than 20° C.

8. The kitchen appliance of claim 4, wherein the difference between the first temperature and the second temperature is not more than 150° ° C.

9. The kitchen appliance of claim 1, wherein the first temperature sensor is pressed against the first layer by a spring and/or that the second temperature sensor is pressed against the first or the second layer by a spring.

10. The kitchen appliance of claim 1, wherein the first temperature sensor is not arranged between two heating conductor tracks and/or is arranged at the edge of the wall.

11. The kitchen appliance of claim 1, wherein the first temperature sensor does not contact the second layer.

12. The kitchen appliance of claim 1, wherein the second temperature sensor is arranged between two heating conductor tracks.

13. The kitchen appliance of claim 1, wherein the first layer consists of steel and the second layer consists of copper or aluminum or comprises copper or aluminum.

14. The kitchen appliance of claim 1, further comprising a control device which is configured such that it regulates heating by the heating conductors in dependence on the first temperature sensor and the second temperature sensor.

15. The kitchen appliance of claim 14, wherein the control device is configured such that it switches off heating by the heating conductor when the first temperature sensor measures a temperature above a first threshold value or when the second temperature sensor measures a temperature above a second threshold value, wherein the first threshold value is smaller than the second threshold value.

16. The kitchen appliance of claim 1, wherein the thermal conductivity of the second layer is greater than the thermal conductivity of the first layer and/or that the second layer is thicker than the first layer.

17. The kitchen appliance of claim 1, wherein the kitchen appliance is a food processor with a stand part, with a preparation vessel insertable into the stand part, and with a chopping and/or mixing device, and wherein the preparation vessel comprises the wall, wherein by means of the chopping and/or mixing device a foodstuff present in the food preparation vessel can be chopped and/or mixed.

18. A kitchen appliance for heating foodstuffs, the kitchen appliance comprising
a wall, and
a heating conductor for heating food, the heating conductor being present in the wall, wherein the wall comprises an outer first layer and, in the wall, a heating conductor, a first temperature sensor and a second temperature sensor, and wherein the distance between the first temperature sensor and the heating conductor is greater than the distance between the second temperature sensor and the heating conductor.

19. A method for manufacturing a kitchen appliance having the features according to claim 1, the method comprising
calibrating the first temperature sensor and the second temperature sensor,
wherein the maximum calibration temperature of the first temperature sensor is smaller than the maximum calibration temperature of the second temperature sensor or in that the maximum calibration temperature of the first temperature sensor is at least different from the maximum calibration temperature of the second temperature sensor.

20. The method of claim 19, wherein the operating point with the highest accuracy is greater for the first temperature sensor than for the second temperature sensor.
